(19) United States
(12) Patent Application Publication
(10) Pub. No.: US 2018/0264501 A1
(43) Pub. Date: Sep. 20, 2018

(54) FILM PRODUCTION APPARATUS, FILM ROLL PRODUCTION APPARATUS, FILM PRODUCTION METHOD, AND FILM ROLL PRODUCTION METHOD

(71) Applicant: Sumitomo Chemical Company, Limited, Tokyo (JP)

(72) Inventor: Koichiro WATANABE, Niihama-shi, Ehime (JP)

(73) Assignee: Sumitomo Chemical Company, Limited, Tokyo (JP)

(21) Appl. No.: 15/548,337

(22) PCT Filed: Jan. 27, 2017
(86) PCT No.: PCT/JP2017/002990

§ 371 Date: Aug. 2, 2017

(30) Foreign Application Priority Data
Jan. 28, 2015 (JP) 2016-014825

(51) Int. Cl. B05C 1/08; B05C 5/02; B05D 1/26; B05D 1/28; B05D 7/04; H01M 2/16

(52) U.S. Cl. CPC B05C 1/0826; B05C 1/0821; B05C 5/0208; H01M 2/16; B05D 1/28; B05D 7/04; B05D 1/26

(57) ABSTRACT

An embodiment of the present invention prevents a defect from occurring in a joint portion, in a case where a film is produced by processing a film original sheet including the joint portion. A coating device carries out processing in different manners, respectively, for a joint portion of a first porous film original sheet and a second porous film original sheet and for portions other than the joint portion.

### TECHNICAL FIELD

The present invention relates to a film production apparatus, a film roll production apparatus, a film production method, and a film roll production method.

### BACKGROUND ART

A lithium ion secondary battery includes a cathode, an anode, and a porous separator for separating the cathode and the anode. A separator for a battery can be obtained by subjecting, to processes such as coating, stretching, and cleaning processes, an original sheet of the separator (hereinafter, referred to as a “separator original sheet”) which serves as a base.

In a process for producing a film such as a separator, an original sheet of the film (hereinafter, referred to as “a film original sheet”) wound off from a roll is continuously processed in processing steps while being transferred. This is intended to improve production efficiency.

Patent Literature 1 discloses a method of joining films by thermal welding, which method is used in a process for producing a film. In a film original sheet feeding device, a rear end portion of a first film original sheet being wound off from a roll currently in use is joined to a forward end portion of a second film original sheet wound on a new roll which is to be used next. As a result, the roll currently in use can be switched to the new roll, while transfer of the film original sheet is not stopped at all. Accordingly, the film original sheet can be continuously transferred to processing steps and processed, even while the roll currently in use is switched to the new roll.

### CITATION LIST

### Patent Literature

[Patent Literature 1] Japanese Patent Application Publication Tokukai No. 2012-153134 (Publication date: Aug. 16, 2012)

### SUMMARY OF INVENTION

### Technical Problem

However, in a case where the first film original sheet of the roll currently in use and the second film original sheet of a new roll which is to be used next are joined to each other, a joint portion of the first film original sheet and the second film original sheet is not equivalent to the other portions of the film original sheet. More specifically, for example, the joint portion has a two-layered structure in which the first and second film original sheets are overlapped with each other and joined to each other. Accordingly, the joint portion is thicker than the other portions. Further, the joint portion more easily tears than the other portions. Meanwhile, in a case where the first film original sheet and the second film original sheet are joined to each other by an adhesive tape, the joint portion differs in physical property from the other portions.

Accordingly, in a case where an entire film original sheet including a joint portion is uniformly processed in subsequent processing steps, a defect may occur in the joint portion.

An embodiment of the present invention is attained in view of the above problem. An object of an embodiment of the present invention is to provide a film production apparatus, a film roll production apparatus, a film production method, and a film roll production method, each of which prevents a defect from occurring in a joint portion in a case where a film is produced by processing a film original sheet including the joint portion.

### Solution to Problem

In order to solve the above problem, a film production apparatus in accordance with an embodiment of the present invention is a film production apparatus for producing a film by subjecting a film original sheet to predetermined processes, the film production apparatus including: a processing device for subjecting, to a process, the film original sheet in which a first film original sheet and a second film original sheet are joined to each other, the processing device carrying out the process in different manners, respectively, for a joint portion of the first film original sheet and the second film original sheet and for portions other than the joint portion.

Moreover, in order to solve the above problem, a film roll production apparatus in accordance with an embodiment of the present invention is a film roll production apparatus for producing a film roll by winding a film in which a first film and a second film are joined to each other, the film roll production apparatus including: a winding device for forming the film roll by winding, on a winding roller, the film excluding a joint portion of the first film and the second film.

Further, in order to solve the above problem, a film production method in accordance with an embodiment of the present invention is a film production method for producing a film by subjecting a film original sheet to predetermined processes, the method including the step of: subjecting, to a process, the film original sheet in which a first film original sheet and a second film original sheet are joined to each other, the step carrying out the process in different manners, respectively, for a joint portion of the first film original sheet and the second film original sheet and for portions other than the joint portion.

Furthermore, in order to solve the above problem, a film roll production method in accordance with an embodiment of the present invention is a film roll production method for producing a film roll by winding a film in which a first film and a second film are joined to each other, the film roll production method comprising the step of: forming the film roll by winding, on a winding roller, the film excluding a joint portion of the first film and the second film.

### Advantageous Effects of Invention

An embodiment of the present invention makes it possible to prevent a defect from occurring in a joint portion in a case where a film is produced by a film original sheet including the joint portion.

### BRIEF DESCRIPTION OF DRAWINGS

FIG. 1 schematically illustrates an arrangement of a cross section of a lithium ion secondary battery 1.

FIG. 2 schematically illustrates states of the lithium ion secondary battery 1 illustrated in FIG. 1.

FIG. 3 schematically illustrates states of the lithium ion secondary battery 1 which has another arrangement.

FIG. 4 is a flow diagram illustrating an outline of a process for producing a heat-resistant separator.

FIG. 5 schematically illustrates a heat-resistant separator production apparatus in accordance with Embodiment 1 of the present invention.

FIG. 6 schematically illustrates a porous film original sheet.

FIG. 7 schematically illustrates a coating process carried out by a coating device.

FIG. 8 schematically illustrates a coating process carried out by another coating device. FIG. 9 schematically illustrates a coating process carried out by another coating device.

FIG. 10 schematically illustrates a deposition process carried out by a deposition device.

FIG. 11 schematically illustrates a coating process carried out by a coating device in accordance with Embodiment 2 of the present invention.

FIG. 12 illustrates a winding process carried out by a heat-resistant separator roll production apparatus in accordance with Embodiment 3 of the present invention.

FIG. 13 illustrates a winding process carried out by a heat-resistant separator roll production apparatus in accordance with Embodiment 4 of the present invention.

FIG. 14 illustrates a winding process carried out by a heat-resistant separator roll production apparatus in accordance with Embodiment 5 of the present invention.

### DESCRIPTION OF EMBODIMENTS

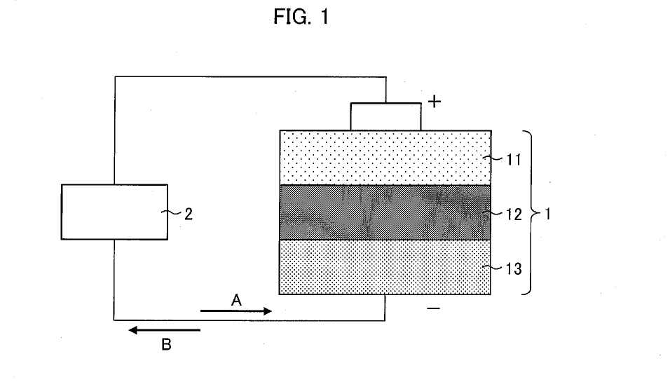

The following description discusses in detail embodiments of the present invention, with reference to FIGS. 1 to 10. The following describes, as an example of a film in accordance with each embodiment of the present invention, a heat-resistant separator for a battery such as a lithium ion secondary battery.

### Embodiment 1

<Arrangement of Lithium Ion Secondary Battery>

A nonaqueous electrolyte secondary battery typified by a lithium ion secondary battery has a high energy density. Thus, such a nonaqueous electrolyte secondary battery is currently widely used not only as a battery for use in (i) devices such as a personal computer, a mobile phone, and a mobile information terminal, and (ii) movable bodies such as an automobile and an airplane, but also as a stationary battery contributive to stable electric power supply.

FIG. 1 schematically illustrates an arrangement of a cross section of a lithium ion secondary battery 1.

As illustrated in FIG. 1, the lithium ion secondary battery 1 includes a cathode 11, a separator 12, and an anode 13. Between the cathode 11 and the anode 13, an external device 2 is connected outside the lithium ion secondary battery 1. While the lithium ion secondary battery is being charged, electrons move in a direction A. Meanwhile, while the lithium ion secondary battery 1 is being discharged, electrons move in a direction B.

<Separator>

The separator 12 is provided so as to be sandwiched between the cathode 11 and the anode 13, which are a positive electrode and a negative electrode, respectively, of the lithium ion secondary battery 1. While separating the cathode 11 and the anode 13, the separator 12 allows lithium ions to move between the cathode 11 and the anode 13. The separator 12 contains, for example, polyolefin (e.g., polyethylene or polypropylene) as a material thereof.

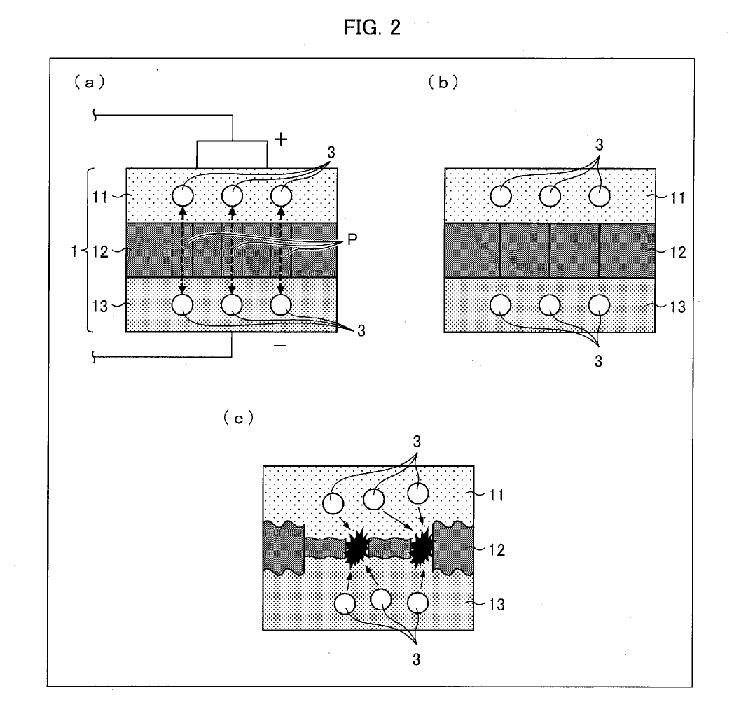

FIG. 2 schematically illustrates states of the lithium ion secondary battery 1 illustrated in FIG. 1. (a) of FIG. 2 illustrates a normal state of the lithium ion secondary battery 1. (b) of FIG. 2 illustrates a state in which the lithium ion secondary battery 1 has increased in temperature. (c) of FIG. 2 illustrates a state in which the lithium ion secondary battery 1 has sharply increased in temperature.

As illustrated in (a) of FIG. 2, the separator 12 is provided with many pores P. Normally, lithium ions 3 in the lithium ion secondary battery 1 can move back and forth through the pores P.

Note here that there may be, for example, a case where the lithium ion secondary battery 1 increases in temperature due to, for example, overcharge of the lithium ion secondary battery 1 or a large current caused by a short circuit having occurred in the external device. In such a case, the separator 12 melts or softens, and the pores P are blocked (see (b) of FIG. 2). As a result, the separator 12 shrinks. This stops the movement of the lithium ions 3, and consequently stops the increase in temperature (described earlier).

Note, however, that the separator 12 suddenly shrinks in a case where the lithium ion secondary battery 1 sharply increases in temperature. In this case, as illustrated in (c) of FIG. 2, the separator 12 may be broken. Then, the lithium ions 3 leak out from the separator 12 which has been broken, so that the lithium ions 3 do not stop moving back and forth. Thus, the increase in temperature continues.

<Heat-Resistant Separator>

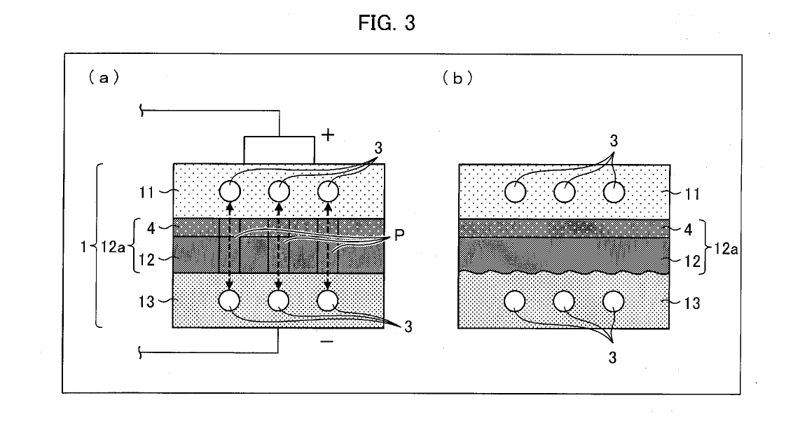

FIG. 3 schematically illustrates states of the lithium ion secondary battery 1 which has another arrangement. (a) of FIG. 3 illustrates a normal state of the lithium ion secondary battery 1. (b) of FIG. 3 illustrates a state in which the lithium ion secondary battery 1 has sharply increased in temperature.

As illustrated in (a) of FIG. 3, the lithium ion secondary battery 1 can further include a heat-resistant layer 4. The heat-resistant layer 4 can be provided to the separator 12. (a) of FIG. 3 illustrates an arrangement in which the heat-resistant layer 4, which serves as a functional layer, is provided to the separator 12. In the following description, a film in which the heat-resistant layer 4 is provided to the separator 12 is regarded as a heat-resistant separator 12a.

According to the arrangement illustrated in (a) of FIG. 3, the heat-resistant layer 4 is laminated to one side of the separator 12 which one side faces the cathode 11. Alternatively, the heat-resistant layer 4 can be laminated to one side of the separator 12 which one side faces the anode 13, or to both sides of the separator 12. Further, the heat- resistant layer 4 is provided with pores that are similar to the pores P. Normally, the lithium ions 3 move back and forth through the pores P and the pores of the heat-resistant layer 4. The heat-resistant layer 4 contains, for example, wholly aromatic polyamide (aramid resin) as a material thereof.

As illustrated in (b) of FIG. 3, even in a case where the lithium ion secondary battery 1 sharply increases in temperature and the separator 12 melts or softens, a shape of the separator 12, which is supported by the heat-resistant layer 4, is maintained. Thus, such a sharp increase in temperature merely results in melting or softening of the separator 12 and consequent blocking of the pores P. This stops the movement of the lithium ions 3 and consequently stops overdischarge or overcharge (described earlier). The separator 12 is thus prevented from being broken.

<Heat-Resistant Separator Production Method (Separator Production Method)>

Next, the following description discusses a production method of a heat-resistant separator by use of a separator production apparatus in accordance with Embodiment 1.

The heat-resistant separator 12a has an arrangement in which a heat-resistant layer is laminated to a porous film that serves as the separator 12. The porous film is made of, for example, polyolefin. In place of the heat-resistant layer, a functional layer such as an adhesive layer can be laminated. The heat-resistant layer is laminated to the porous film, by coating a surface of the porous film with a coating material or the like that is suited to the functional layer, and drying the porous film coated with the coating material or the like.

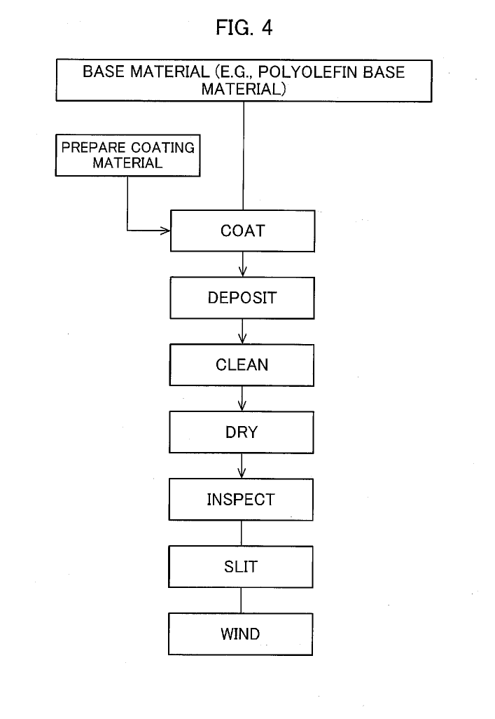

FIG. 4 is a flow diagram schematically showing a process for producing a heat-resistant separator.

In a flow illustrated as an example in FIG. 4, wholly aromatic polyamide (aramid resin) is used as a material of the heat-resistant layer and laminated to a polyolefin base material.

In the case of a process for producing a heat-resistant separator which includes a heat-resistant layer made of aramid resin, the following steps (a) through (f) are carried out in the order from (a) to (f): (a) a porous film winding-off and checking step, (b) a coating step of applying a coating material (functional material), (c) a deposition step carried out by, for example, humidity deposition, (d) a cleaning step, (e) a drying step, and (f) a coated article inspecting step.

On the other hand, in the case of a process for producing a heat-resistant separator which contains an inorganic filler as a main component, the following steps are carried out in the order as follows: (a) a porous film winding-off and checking step; (b) a coating step of applying a coating material (functional material); (e) a drying step; and (f) a coated article inspecting step.

Meanwhile, in the case of a process for producing a heat-resistant separator roll, the process includes (g) a winding step in addition to the above steps.

Note that in addition to the above steps (a) through (g), in some cases, a base material producing (film-forming) step may be provided before the (a) base material winding-off and checking step, and/or a slitting step may be provided after the (g) winding step.

The following description discusses the above steps in the order of the steps (a) to (g).

(a) Base Material Winding-Off and Checking Step

The (a) base material winding-off and checking step includes sub-steps of: winding off, from a roll, a porous film (an original sheet of a film (hereinafter, referred to as a “film original sheet”) serving as the base material of the heat- resistant layer; and checking the wound-off porous film in advance of the subsequent coating step.

(b) Coating Step of Applying a Coating Material

The (b) coating step of applying a coating material is a step of coating, with a coating material as the functional material, the porous film which has been wound off in the step (a). The following description discusses a method for laminating the heat-resistant layer to the porous film. Specifically, the porous film is coated with an N-methyl-pyrolidone (NMP) solution of aramid, which serves as a coating material for formation of the heat-resistant layer. Note that the heat-resistant layer is not limited to the above aramid heat-resistant layer. For example, the porous film can be coated with, for example, a suspension containing an inorganic filler (a suspension containing alumina, carboxymethylcellulose, and water), which suspension serves as a coating material for formation of the heat-resistant layer. A method for coating the porous film with a coating material is not particularly limited provided that uniform wet coating can be carried out by the method. The method can be exemplified by various methods such as a capillary coating method, a slit die coating method, a spray coating method, a dip coating method, a roller coating method, a screen printing method, a flexo printing method, a gravure coater method, a bar coater method, and a die coater method. Further, the heat-resistant layer 4 has a thickness which can be controlled by adjusting a thickness of a coating material with which the porous film is coated, or adjusting a solid-content concentration of a coating material.

(c) Deposition Step

The (c) deposition step is a step of solidifying the coating material with which the porous film has been coated in the step (b). In a case where the coating material is an NMP solution of aramid, aramid is solidified by, for example, providing vapor to a coating surface and thereby causing humid deposition.

(d) Cleaning Step

The (d) cleaning step is a step of removing a solvent by cleaning the coating material having undergone the (c) deposition step. As a result of removal of the solvent, an aramid heat-resistant layer is formed on the base material. In a case where the heat-resistant layer is the aramid heat- resistant layer, water, an aqueous solution, or an alcoholic solution, for example, is suitably used as a cleaning liquid.

(e) Drying Step

The (e) drying step is a step of drying the heat-resistant separator which has been cleaned in the step (d). A method for drying the heat-resistant separator is not particularly limited but can be any of various methods such as a method of bringing the heat-resistant separator into contact with a heated roll, and a method of blowing hot air onto the heat-resistant separator. Note that in the case of forming a heat-resistant layer which contains an inorganic filler as a main component, the heat-resistant layer is formed on a porous film by: carrying out the (e) drying step after coating the porous film with a suspension (coating material) which contains an inorganic filler; and then removing a solvent.

(e) Inspecting Step

The (e) inspecting step is a step of inspecting the dried heat-resistant separator. In this inspection, a defective portion may be marked as appropriate so that the defective portion can be easily removed.

(f) Winding Step

The (f) winding step is a step of winding the heat- resistant separator which has been inspected so as to form a heat-resistant separator roll. In this winding, for example, a cylindrical roll can be used as appropriate. Note that, if needed, the heat-resistant separator prior to winding can be first formed into a slit heat-resistant separator by slitting so as to have a narrower width such as a product width, so that a heat-resistant separator roll can be formed by winding the slit heat-resistant separator.

<Heat-Resistant Separator Production Apparatus>

As described above, the process for producing a heat-resistant separator includes processing steps such as a winding-off step, a coating step, a deposition step, a cleaning step, a drying step, an inspecting step, and a slitting step.

The heat-resistant separator production apparatus in accordance with Embodiment 1 includes processing devices which correspond to the above processing steps and carry out the processing steps, respectively.

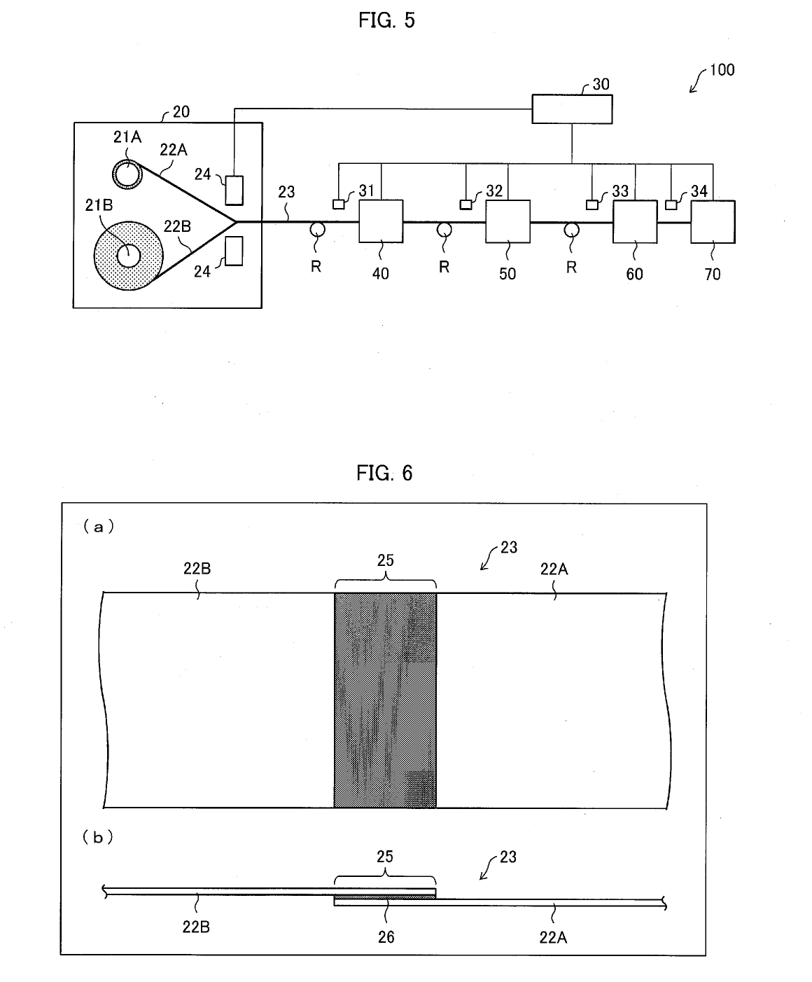

FIG. 5 schematically illustrates a heat-resistant separator production apparatus in accordance with Embodiment 1.

As illustrated in FIG. 5, a heat-resistant separator production apparatus 100 (film production apparatus) includes a winding-off device 20 (feeding device), a joint detecting device 30, a coating device 40, a deposition device 50, a drying device 60, an inspection device 70, and rollers R (transfer device).

(Winding-Off Device)

As illustrated in FIG. 5, the winding-off device 20 includes a roll 21A on which a porous film 22A (first film original sheet) is wound, a roll 21B on which a porous film 22B (second film original sheet) is wound, and a joining section 24 for joining the porous films 22A and 22B to each other.

The winding-off device 20 winds off the porous film 22A from the roll 21A and the porous film 22B from the roll 21B, and feeds, to subsequent steps, the porous films 22A and 22B as a porous film original sheet 23 (film original sheet).

The joining section 24 joins the porous film 22A wound on the roll 21A with the porous film 22B wound on the roll 21B, when only a little amount of the porous film 22A remains on the roll 21A.

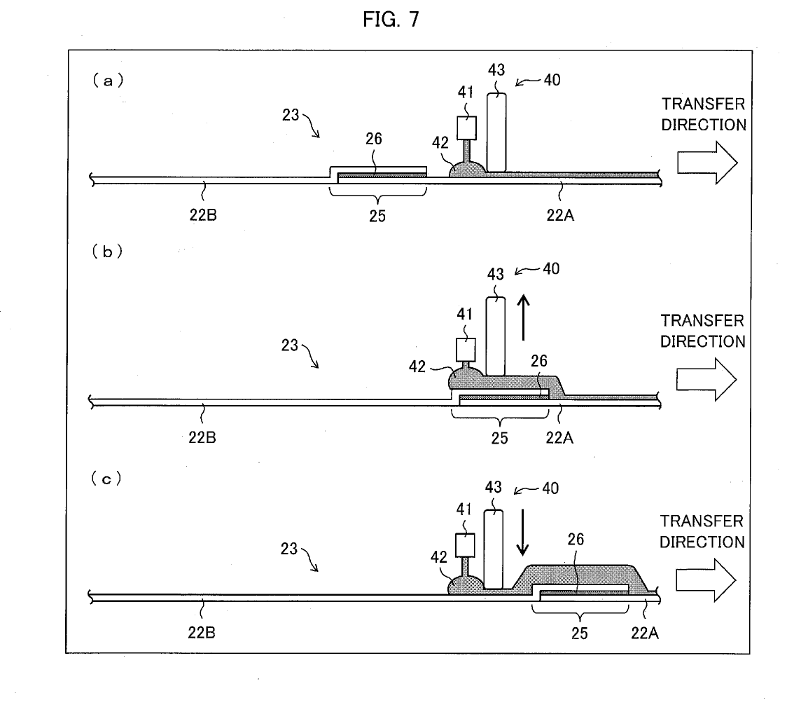

FIG. 6 schematically illustrates a porous film original sheet. (a) of FIG. 6 is a plan view, and (b) of FIG. 6 is a side view.

As illustrated in (a) and (b) of FIG. 6, a rear end portion of the preceding porous film 22A and a forward end portion of the subsequent porous film 22B form a joint portion 25 where the porous films 22A and 22B are joined to each other. The joining section 24 applies an adhesive agent 26 to the forward end portion of the porous film 22B, and presses the forward end portion of the porous film 22B onto the rear end portion of the preceding porous film 22A. As a result, the porous films 22A and 22B are joined to each other via the adhesive agent 26.

The adhesive agent 26 is preferably an olefin-based elastomer such as Tafthren (registered trademark) resin. An olefin-based adhesive agent 26 is highly resistant to a polar solvent such as N-methyl-pyrolidone (NMP), acetone, or water, and particularly to a non-protonic polar solvent such as NMP. Accordingly, in a coating process described later, even when a solvent medium (solvent) penetrates through the porous film 22A or 22B and reaches the adhesive agent 26 in a case where a coating material containing N-methyl- pyrolidone (NMP) is used as the solvent medium, peeling of the porous film 22A or 22B in the joint portion 25 will not be caused by decrease in adhesive force.

Note that the joining section 24 can join porous films to each other by a double-sided adhesive tape instead of the adhesive agent 26, or alternatively, by thermal welding of porous films overlapped on each other.

After the porous films 22A and 22B are joined to each other, the porous film 22A is cut on a downstream side of the joint portion 25 of the porous films 22A and 22B. Then, the roll 21A is replaced by another roll on which another porous film is wound. Subsequently, when only a little amount of the porous film 22B remains wound on the roll 21B, the another porous film wound on the another roll newly provided as above is joined to the porous film 22B.

Repeating the above, the winding-off device 20 can continuously wind off and feed, to subsequent steps, a porous film original sheet 23 which is obtained by joining a porous film 22A and a porous film 22B.

(Rollers)

As illustrated in FIG. 5, the rollers R transfer the porous film original sheet 23 which has been wound off from the winding-off device 20. The porous film original sheet 23 is transferred to the coating device 40, the deposition device 50, the drying device 60, and the inspection device 70 in this order.

The heat-resistant separator production apparatus 100 includes, as the rollers R, drive rollers each of which has driving force for exerting transfer force on the porous film original sheet 23, and driven rollers each of which adjusts a transfer direction of the porous film original sheet 23 by guiding the porous film original sheet 23.

Though for convenience of description, FIG. 5 illustrates an example in which three rollers R are aligned on a straight line, a larger number of rollers R can be provided in practice such that the rollers R can adjust the transfer direction of the porous film original sheet 23 in various directions.

(Joint Portion Detecting Device)

The joint detecting device 30 transmits a time at which the joint portion 25 reaches a processing device and processing is to be started. Such a time can be a time at which the joint portion 25 is detected by each of detectors 31 to 34 which are provided before (preferably, immediately before) respective devices (the coating device 40, the deposition device 50, the drying device 60, and the inspection device 70) so as to detect the joint portion 25. Alternatively, such a time can be a time obtained by calculation on the basis of the speed of transfer carried out by the rollers R and a distance of transfer from a position at which the joining section 24 joins the porous films 22A and 22B to each of the processing devices (the coating device 40, the deposition device 50, the drying device 60, and the inspection device 70).

Since the joint detecting device 30 transmits, to each of the processing devices, a time at which the joint portion 25 reaches each of the processing devices, each of the processing devices can switch between a manner for processing the joint portion 25 and a manner for processing portions other than the joint portion 25 at appropriate times.

Note that, though the joint detecting device 30 is configured as a part separate from each of the processing devices in the heat-resistant separator production apparatus 100 illustrated in FIG. 5 as an example, an embodiment of the present invention is not limited to this configuration. The joint detecting device 30 can be provided inside each of the processing devices.

(Coating Device)

The heat-resistant separator production apparatus 100 in accordance with Embodiment 1 includes the coating device 40 for carrying out a bar coating method. The following description discusses a coating process carried out by the coating device 40.

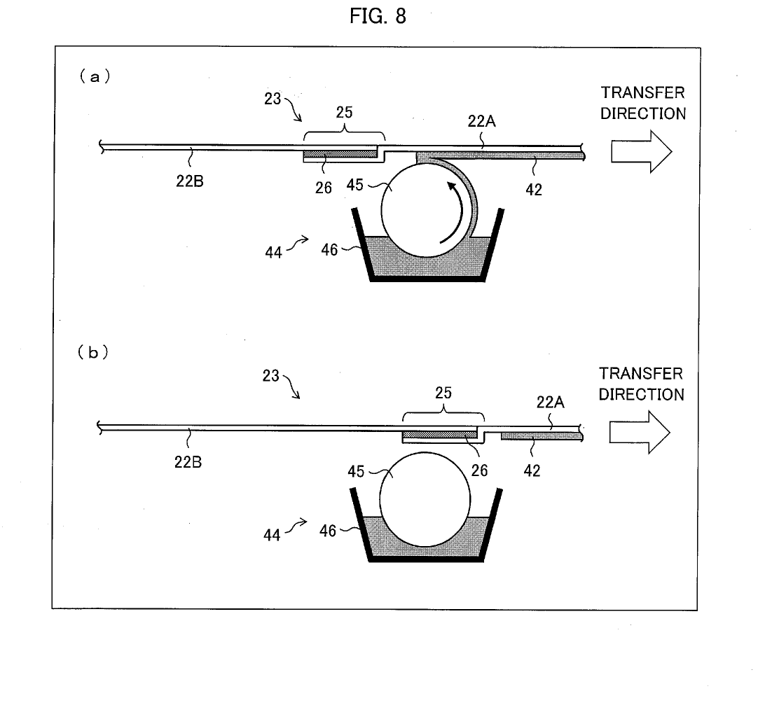

FIG. 7 schematically illustrates a coating process that is carried out by the coating device 40 of Embodiment 1. (a) of FIG. 7 illustrates a state in which a first porous film is being coated, (b) of FIG. 7 illustrates a state in which a coating bar is moved up, and (c) of FIG. 7 illustrates a state in which a second porous film which follows the first porous film is being coated.

As illustrated in (a) of FIG. 7, the coating device 40 includes a coating material dropping section 41 and a coating bar 43 (coating section). The coating material dropping section 41 and the coating bar 43 are provided in this order along the transfer direction.

While the porous film original sheet 23 is transferred in a coating process, the porous film original sheet 23 is in a state in which a lower surface (surface supported by rollers) of the porous film 22A of the porous film original sheet 23 is aligned with a lower surface of the porous film 22B of the porous film original sheet 23 except for the joint portion 25. Accordingly, the porous film original sheet 23 is transferred in a state in which only a portion of an upper surface of the porous film original sheet 23 in the joint portion 25 of the porous film 22B is in a higher position as compared to the other portions of the upper surface (surface to be coated) of the porous film original sheet 23.

The coating material dropping section 41 drops a coating material 42 onto the porous film original sheet 23 that is being transferred. The coating bar 43 is provided so as to have a predetermined space between the coating bar 43 and the porous film original sheet 23. With this arrangement, the coating bar 42 smoothens the coating material 42 which has been dropped onto the porous film original sheet 23, and the coating material 42 is uniformly applied on a surface of the porous film original sheet 23.

This allows the coating device 40 to uniformly apply the coating material 42 to the surface of the porous film original sheet 23 that is being transferred. Note that the coating material 42 can be a coating material containing, for example, NMP as a solvent medium.

As illustrated in (b) of FIG. 7, when the joint portion 25 reaches the coating device 40, the coating bar 43 moves up. This increases the distance between the coating bar 43 and the porous film original sheet 23. Note that as described above, the joint detecting device 30 notifies, to the coating device 40, a time at which the joint portion 25 reaches the coating device 40.

As illustrated in (c) of FIG. 7, after the joint portion 25 has passed under the coating bar 43, the coating bar 43 moves down back to a position of the coating bar 43 prior to moving up. Then, the coating bar 43 smoothens again the coating material 42 which has been dropped onto the porous film original sheet 23.

In the coating process, in a case where the coating bar 43 is fixed at a constant height and the coating process is uniformly carried out all over the porous film original sheet 23 including the joint portion 25, a defect such as peeling of the porous film 22A or 22B in the joint portion 25 may occur when the coating bar 43 comes in proximity to or in contact with the joint portion 25 and stress is applied onto the joint portion 25. In the case of a thin and porous separator, particularly wrinkling and peeling easily occur and tend to cause a defect.

On the other hand, according to the heat-resistant separator production method (film production method) carried out by the heat-resistant separator production apparatus 100 in accordance with Embodiment 1, the coating bar 43 is caused to move up at the time when the joint portion 25 reaches the coating device 40. Further, the coating process on the joint portion 25 and on portions other than the joint portion 25 is carried out in different manners, respectively. This makes it possible to prevent the coating bar 43 from coming in proximity to or coming in contact with the joint portion 25 in the coating process. This consequently prevents peeling of the porous film 22A or 22B in the joint portion 25 and wrinkling both of which may be caused by application of stress onto the joint portion 25.

Note that though the above description has dealt with the coating device 40 for carrying out the bar coating method, an arrangement of the coating device is not limited to this arrangement. The coating device 40 only needs to be a coating device employing a coating section that comes in proximity to or in contact with the porous film original sheet 23 so as to apply a coating material onto a surface of the porous film original sheet 23. The coating device 40 can be, for example, a coating device for carrying out a gravure method which coating device employs a gravure roll as the coating section or a coating device for carrying out a die coating method which coating device employs a die coater as the coating section.

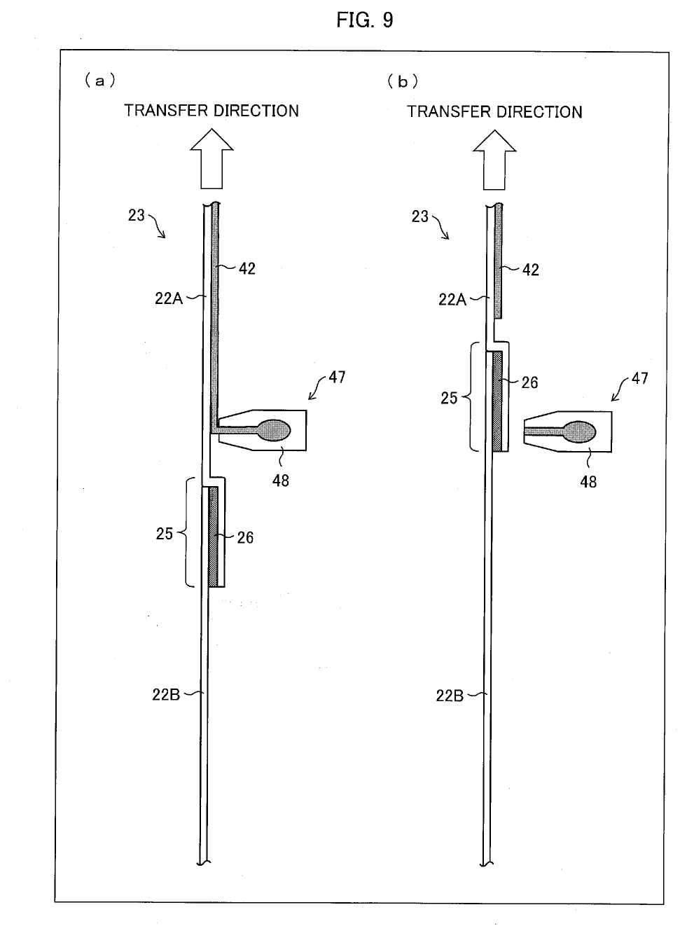

FIG. 8 schematically illustrates a state in which the porous film original sheet 23 is being coated with a coating material 42, by use of a coating device 44 including a gravure roll 45 as a coating section.

As illustrated in (a) of FIG. 8, the gravure roll 45 of the coating device 44 has an outer peripheral surface at least a portion of which is in contact with the coating material 42 in a coating material source 46. The coating material 42 attached to the outer peripheral surface of the gravure roll 45 is carried toward the porous film original sheet 23 as the gravure roll 45 rotates. Then, when the coating material 42 attached to the outer peripheral surface of the gravure roll 45 comes in contact with the porous film original sheet 23, the porous film original sheet 23 is coated with the coating material 42.

FIG. 8 illustrates, as an example, a case where the coating device 44 employs a reverse gravure coating method. In other words, in a contact surface area where the porous film original sheet 23 and the coating material 42, which is attached to the outer peripheral surface of the gravure roll 45, come in contact with each other, the gravure roll 45 rotates such that a direction in which the outer peripheral surface of the gravure roll 45 moves is opposite to a direction in which the porous film original sheet 23 is transferred. The coating device 44, however, is not limited to such an arrangement. The gravure roll 45 can be arranged to rotate in a direction in which the porous film original sheet 23 is transferred.

Next, when the joint portion 25 of the porous film original sheet 23 comes in proximity to the gravure roll 45, the gravure roll 45 moves away from the porous film original sheet 23, as illustrated in (b) of FIG. 8. Since the coating material 42 attached to the outer peripheral surface of the gravure roll 45 is accordingly put out of contact with the porous film original sheet 23, the porous film original sheet 23 is not coated with the coating material 42 in the joint portion 25.

FIG. 9 schematically illustrates a state in which the porous film original sheet 23 is being coated with a coating material 42, by use of a coating device 47 including a slit die coater head 48 as a coating section.

As illustrated in (a) of FIG. 9, the coating material 42 is supplied through a slit of the slit die coater head 48 of the coating device 47. Accordingly, when the coating material 42 from the slit of the slit die coater head 48 comes in contact with the porous film original sheet 23 being transferred, the porous film original sheet 23 is coated with the coating material 42.

Next, when the joint portion 25 of the porous film original sheet 23 comes in proximity to the slit die coater head 48, the slit die coater head 48 moves away from the porous film original sheet 23, as illustrated in (b) of FIG. 9. Since the coating material 42 supplied from the slit die coater head 48 is accordingly put out of contact with the porous film original sheet 23, the porous film original sheet 23 is not coated with the coating material 42 in the joint portion 25.

As described above, in cases where either of the above coating methods illustrated in FIGS. 8 and 9, respectively, is employed, only the joint portion 25 of the porous film original sheet 23 may not be subjected to the coating process. In such cases, the gravure roll 45 or the slit die coater head 48 can be prevented from coming in vicinity to or in contact with the joint portion 25 in the coating process. This makes it possible to prevent peeling or wrinkling in the joint portion 25 from occurring due to application of stress to the joint portion 25.

(Deposition Device)

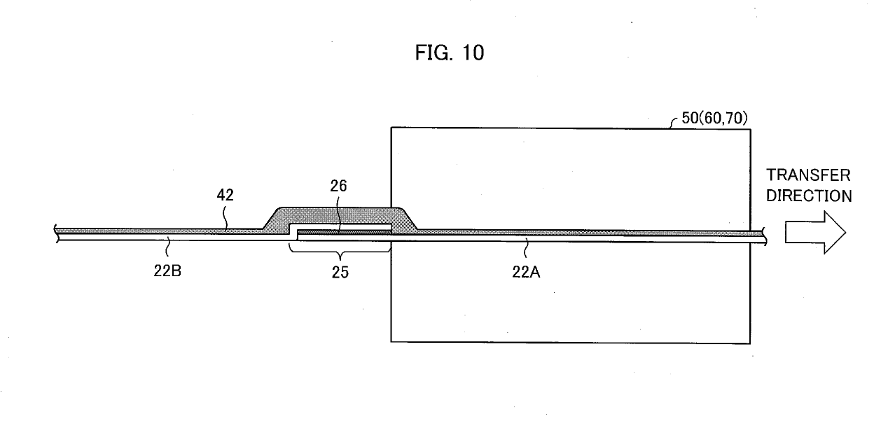

FIG. 10 schematically illustrates a deposition process that is carried out by the deposition device 50.

The deposition device 50 carries out the deposition process after the coating process. The deposition device 50 carries out the deposition process on the porous film original sheet 23 such that a depositing capacity in a case where the joint portion 25 is subjected to the deposition process is changed, in accordance with the coating process to the joint portion 25, from that in a case where portions other than the joint portion 25 are subjected to the deposition process. Note that as described above, the joint detecting device 30 notifies, to the deposition device 50, a time at which the joint portion 25 reaches the deposition device 50.

As illustrated in FIG. 10, in a case where the coating process is carried out by using the coating device 40 in accordance with Embodiment 1, the coating material 42 in the joint portion 25 has a film thickness that is different from a film thickness of the coating material 42 in portions other than the joint portion 25.

Accordingly, in a case where the depositing capacity in the deposition process is fixed and the deposition process is uniformly carried out all over the porous film original sheet 23 including the joint portion 25, a defect, such as attachment of the coating material 42 to rollers, may occur in a subsequent step due to inappropriate deposition in the joint portion 25.

In order to solve this problem, the heat-resistant separator production apparatus 100 in accordance with Embodiment 1 changes the depositing capacity at a time when the joint portion 25 reaches the deposition device 50. This allows the joint portion 25 and portions other than the joint portion 25 to be subjected to the deposition process in different manners, respectively. As a specific method of changing the depositing capacity, there is, for example, a method in which a volume of air for supplying vapor to the deposition device 25 is changed, a method in which an absolute vapor amount is changed by changing the temperature of the vapor, or a method in which the length of a time for the deposition process is changed by changing a transfer speed of the porous film original sheet 23. This makes it possible to prevent the joint portion 25 from being insufficiently deposited in the deposition process.

(Drying Device)

Note that it is preferable to change, in accordance with the coating process to the joint portion 25, a processing capacity for the joint portion 25 in the drying process, as in the deposition process. The following description discusses the drying process with reference to FIG. 10.

The drying device 60 carries out the drying process after the coating process, the deposition process, and a cleaning process. The drying device 60 carries out the drying process to the porous film original sheet 23 such that a drying capacity in a case where the joint portion 25 is subjected to the drying process is different from a drying capacity in a case where portions other than the joint portion 25 are subjected to the drying process. Note that as described above, the joint detecting device 30 notifies, to the drying device 60, a time at which the joint portion 25 reaches the drying device 60.

As illustrated in FIG. 10, the coating material 42 of the joint portion 25 has a film thickness that is different from a film thickness of the coating material 42 of portions other than the joint portion 25. Accordingly, in a case where the drying capacity in the drying process is fixed and the drying process is uniformly carried out all over the porous film original sheet 23 including the joint portion 25, a defect may occur in a subsequent step due to inappropriate drying in the joint portion 25. Such a defect includes, for example, peeling of a portion of the joint portion 25 which has been inappropriately dried.

In order to solve this problem, the heat-resistant separator production apparatus 100 in accordance with Embodiment 1 changes the drying capacity at a time when the joint portion 25 reaches the drying device 60. This allows the joint portion 25 and portions other than the joint portion 25 to be subjected to the drying process in different manners, respectively. As a specific method of changing the drying capacity of the drying device 60, there is, for example, a method in which the temperature of a heated roll is changed, a method in which an amount of hot air to be supplied is changed, a method in which the temperature of the hot air is changed, or a method in which the length of a time for the drying device 60 is changed by changing a transfer speed of the porous film original sheet 23. This makes it possible to prevent the joint portion 25 from being inappropriately dried in the drying process.

(Inspection Device)

In general, the joint portion 25 is cut from a heat-resistant separator 12a which is obtained from the porous film original sheet 23 including the joint portion 25. In this case, there is no need to determine, in the inspecting step, whether the joint portion 25 is good or not.

Accordingly, in the heat-resistant separator production apparatus 100 in accordance with Embodiment 1, the joint portion 25 is not inspected by the inspection device 70. The following description discusses an inspection carried out by the inspection device 70, with reference to FIG. 10.

The inspection device 70 carries out an inspection (inspection process) of the porous film original sheet 23 after the coating process, the deposition process, the cleaning process, and the drying process. Examples of inspection items encompass defects such as the presence of a crack, a foreign substance, and uneven coating, an amount of the coating material per unit area, film thickness, and the like. For example, the inspection device 70 can be arranged to irradiate the porous film original sheet 23 with light and detect a defect in the porous film original sheet 23 on the basis of an optical transmittance in the porous film original sheet 23.

The inspection device 70 stops inspecting when the joint portion 25 reaches the inspection device 70. Specifically, in a case where the inspection device 70 is arranged to detect a defect on the basis of an optical transmittance in the porous film original sheet 23, the inspection device 70 stops light irradiation. Note that, as described above, the joint detecting device 30 notifies, to the inspection device 70, a time at which the joint portion 25 reaches the inspection device 70.

The above arrangement allows the inspection device 70 to omit an unnecessary inspection.

Note that as described above, in the case of a process for producing a heat-resistant separator which contains an inorganic filler as a main component, the following steps are carried out in the order as follows: (a) the porous film winding-off and checking step; (b) the coating step of applying a coating material (functional material); (e) the drying step; and (f) the coated article inspecting step. Meanwhile, it is not necessary to include the deposition step and the cleaning step. In a case where the deposition step and the cleaning step are not included, the heat-resistant separator production apparatus 100 does not need to include the deposition device 50 and the drying device 60.

### Embodiment 2

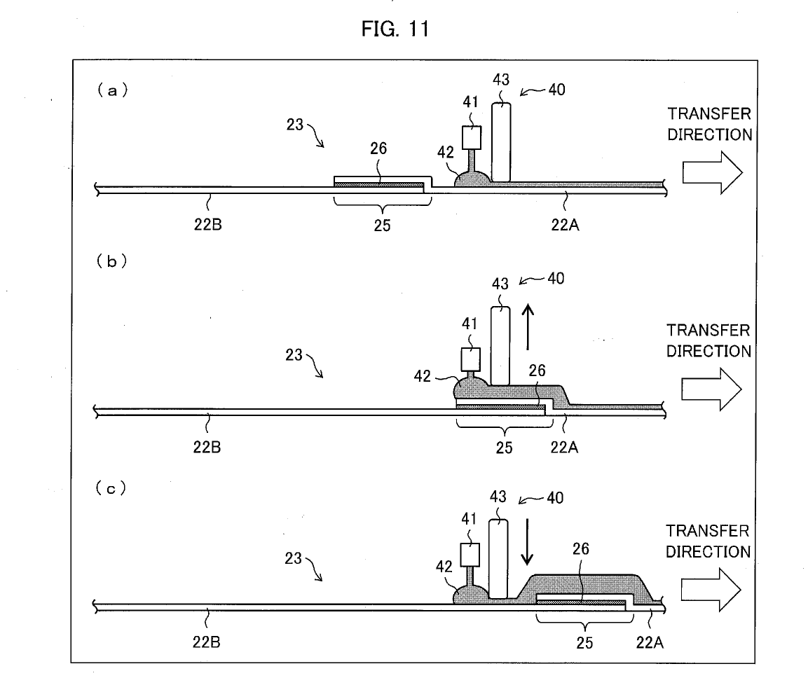

The following description discusses anther embodiment of the present invention, with reference to FIG. 11. Note that for convenience of description, each member identical to that described in Embodiment 1 is given an identical reference sign and a detailed description thereof will be omitted.

FIG. 11 schematically illustrates a coating process that is carried out by a coating device 140 of Embodiment 2. (a) of FIG. 11 illustrates a state in which a first porous film is being coated, (b) of FIG. 11 illustrates a state in which a coating bar 43 is moved up, and (c) of FIG. 11 illustrates a state in which a second porous film which follows the first porous film is being coated.

As illustrated in (a) of FIG. 11, a porous film original sheet 23 to be transferred into the coating device 140 in accordance with Embodiment 2 is different from that of Embodiment 1, only in that a positional relation of a porous film 22A and a porous film 22B in the porous film original sheet 23 in Embodiment 2 is opposite to that in Embodiment 1.

In other words, the porous film original sheet 23 in Embodiment 2 is transferred in a state in which in the joint portion 25, the porous film 22A is provided so as to be closer to the coating bar 43 than the porous film 22B which follows the porous film 22A.

Accordingly, the coating device 140 carries out the coating process all over a surface of the porous film original sheet 23 when portions other than the joint portion 25 are coated. Meanwhile, in a case where the joint portion 25 is coated, the coating device carries out the coating process on only the porous film 22A which is closer to the coating bar 43 but not on the porous film 22B which is farther from the coating bar 43.

In this arrangement, even in a case where the coating bar 43 comes in proximity to or in contact with the joint portion 25, the coating bar 43 applies no stress in a direction in which the stress causes peeling of the porous film 22A or 22B in the joint portion 25 of the porous film original sheet 23. This makes it possible to prevent peeling of the porous film 22A or 22B in the joint portion 25.

### Embodiment 3

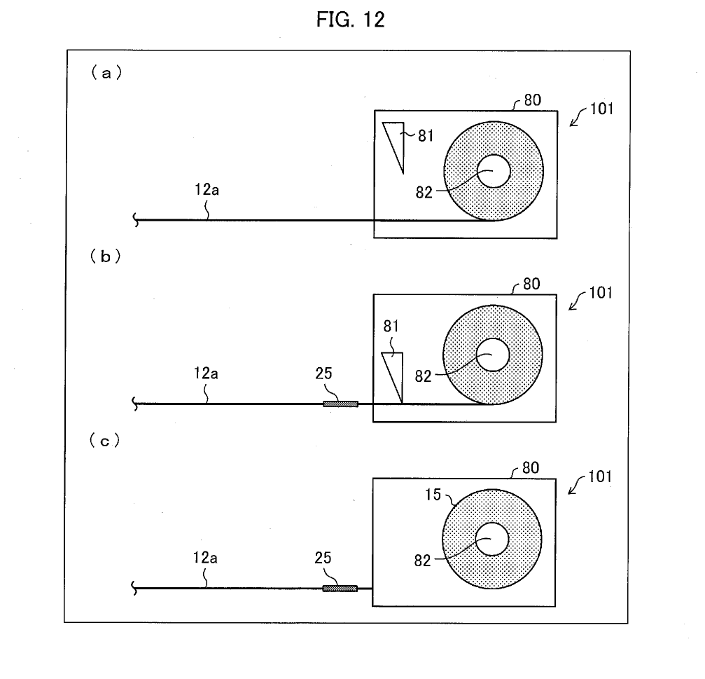

The following description discusses anther embodiment of the present invention, with reference to FIG. 12. Note that for convenience of description, each member identical to that described in the above Embodiment 1 or 2 is given an identical reference sign and a detailed description thereof will be omitted.

FIG. 12 illustrates a winding process of a heat-resistant separator roll production apparatus in accordance with Embodiment 3. (a) of FIG. 12 illustrates a state in which a heat-resistant separator is being wound, (b) of FIG. 12 illustrates a state in which the heat-resistant separator is being cut, and (c) of FIG. 12 illustrates a resultant heat- resistant separator roll.

The heat-resistant separator roll production apparatus 101 (film roll production apparatus) is an apparatus for producing a heat-resistant separator roll 15 (film roll) that is obtained by winding a heat-resistant separator 12a in which a first heat-resistant separator (first film) and a second heat-resistant separator (second film) are joined to each other.

The heat-resistant separator roll production apparatus 101 includes a heat-resistant separator production apparatus 100 which is described in Embodiment 1 or 2, and a winding device 80 for carrying out a winding process of the heat-resistant separator 12a.

As illustrated in (a) of FIG. 12, the winding device 80 includes a cutter 81 and a winding roller 82. The winding roller 82 is a cylindrical member and rotates on an axis while receiving drive force that is provided by a revolving member (not illustrated), so that the winding roller 82 winds the heat-resistant separator 12a on an outer peripheral surface of the winding roller 82.

As illustrated in (b) of FIG. 12, the cutter 81 cuts the heat-resistant separator 12a after completion of winding of the heat-resistant separator 12a on the winding roller 82. The cutter 81 here cuts the heat-resistant separator 12a on an upstream side of a joint portion 25. Note that the winding device 80 is notified, by a joint detecting device 30, of a time at which the joint portion 25 reaches the winding device 80.

As illustrated in (c) of FIG. 12, a roll production method (film roll production method) employing the winding device 80 in accordance with Embodiment 3 makes it possible to wind, on the winding roller 82, the heat-resistant separator 12a excluding the joint portion 25. Therefore, it is possible to produce the heat-resistant separator roll 15 which is obtained by winding only a necessary portion of the heat-resistant separator 12a and excludes the joint portion 25 unnecessary for the heat-resistant separator roll 15 as a product.

### Other Examples

The above description has dealt with the heat-resistant separator roll production apparatus 101, as an example, which includes the heat-resistant separator production apparatus 100 described in Embodiment 1 or 2, and the winding device 80 for carrying out a winding process of a resultant heat-resistant separator 12a.

However, an arrangement of the heat-resistant separator roll production apparatus 101 is not limited to such an arrangement. The heat-resistant separator roll production apparatus 101 can include a conventionally publicly-known heat-resistant separator production apparatus, and the winding device 80 for carrying out a winding process of a resultant heat-resistant separator.

Further, the above description has dealt with the winding device 80 for carrying out a winding process of a heat-resistant separator 12a which is obtained by subjecting a porous film original sheet 23 to predetermined processes.

However, use of the winding process carried out by the winding device 80 in accordance with Embodiment 3 is not limited to a case where the heat-resistant separator 12a is wound but can be applied to production of a roll by winding a porous film original sheet 23 prior to production of the heat-resistant separator 12a.

More specifically, for example, the above winding process can be used in the step of winding a film 22C which has been obtained by rolling polyolefin and subjected to cleaning with hydrochloric acid.

Further, the above winding process can also be used, for example, in the step of winding a film 22D which has been wound off and stretched.

### Embodiment 4

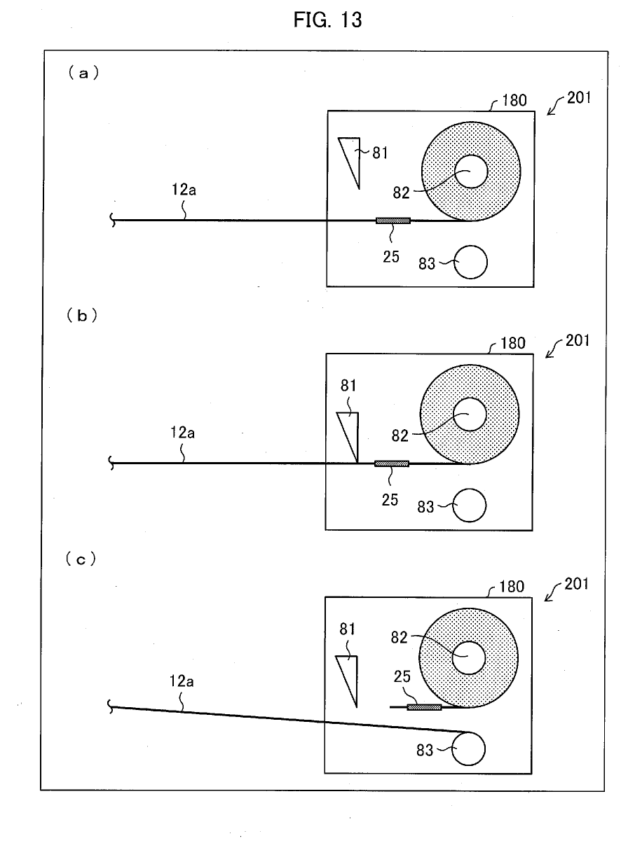

The following description discusses anther embodiment of the present invention, with reference to FIG. 13. Note that for convenience of description, each member identical to that described in any of the above Embodiments 1 to 3 is given an identical reference sign and a detailed description thereof will be omitted.

FIG. 13 illustrates a winding process which is carried out by a heat-resistant separator roll production apparatus in accordance with Embodiment 4. (a) of FIG. 13 illustrates a state in which a heat-resistant separator is being wound on a roller, (b) of FIG. 13 illustrates a state in which the heat- resistant separator is being cut, and (c) of FIG. 13 illustrates a state in which the heat-resistant separator is being wound on another roller.

The heat-resistant separator roll production apparatus 201 (film roll production apparatus) is an apparatus for producing a heat-resistant separator roll 15 (film roll) that is obtained by winding a heat-resistant separator 12a in which a first heat-resistant separator (first film) and a second heat-resistant separator (second film) are joined to each other.

The heat-resistant separator roll production apparatus 201 includes a heat-resistant separator production apparatus 100 which is described in Embodiment 1 or 2, and a winding device 180 for carrying out a winding process of the heat-resistant separator 12a. [0120]

As illustrated in (a) of FIG. 13, the winding device 180 includes a cutter 81, and a winding roller 82 (first roller) and a winding roller 83 (second roller). The winding roller 82 and the winding roller 83 each are a cylindrical member and rotate on an axis while receiving drive force that is provided by a revolving member (not illustrated), so that the winding rollers 82 and 83 each wind the heat-resistant separator 12a on an outer peripheral surface of the winding roller 82 or the winding roller 83. (a) of FIG. 13 illustrates a state in which the heat-resistant separator 12a is being wound on the winding roller 82. [0121] As illustrated in (b) of FIG. 13, the cutter 81 cuts the heat-resistant separator 12a after not less than a predetermined length of the heat-resistant separator 12a is wound on the winding roller 82. The cutter 81 here cuts the heat-resistant separator 12a on a downstream side of a joint portion 25. For example, the cutter 81 can cut the heat- resistant separator 12a at a distance of several meters from the joint portion 25 on the downstream side of the joint portion 25. Note that the winding device 180 is notified, by a joint detecting device 30, of a time at which the joint portion 25 reaches the winding device 180.

As illustrated in (c) of FIG. 13, after the heat-resistant separator 12a is cut, the winding device 180 switches from the winding roller 82 to the winding roller 83 and winds, on the winding roller 83, the heat-resistant separator 12a on a downstream side of a cut position of the heat-resistant separator 12a.

On the other hand, in a case where the heat-resistant separator 12a is cut on an upstream side of the joint portion 25 and the heat-resistant separator 12a on a downstream side of a cut position of the heat-resistant separator 12a is wound on the winding roller 83, the joint portion 25 is located on an inner peripheral side of the winding roller 83. In this case, the joint portion 25 cannot be cut from the heat-resistant separator 12a that is wound on the winding roller 83.

In order to solve this problem, a roll production method (film roll production method) employing the winding device 180 in accordance with Embodiment 4 makes it possible to wind the heat-resistant separator 12a such that the joint portion 25 is located on an outer peripheral side of the winding roller 82. This makes it possible not only to easily cut the joint portion 25 from the heat-resistant separator 12a that is wound on the winding roller 82 but also to prevent the joint portion 25 from being wound on the winding roller 83.

This consequently makes it possible to produce heat-resistant separator rolls 15 which are obtained by winding, on the winding rollers 82 and 83, respectively, the heat-resistant separator 12a excluding the joint portion 25.

### <Other Examples>

The above description has dealt with the heat-resistant separator roll production apparatus 201, as an example, which includes the heat-resistant separator production apparatus 100 described in Embodiment 1 or 2, and the winding device 180 for carrying out a winding process of a resultant heat-resistant separator 12a.

However, an arrangement of the heat-resistant separator roll production apparatus 201 is not limited to such an arrangement. The heat-resistant separator roll production apparatus 201 can include a conventionally publicly-known heat-resistant separator production apparatus, and the winding device 180 for carrying out a winding process of a resultant heat-resistant separator.

Further, the above description has dealt with the winding device 180 for carrying out a winding process of a heat-resistant separator 12a which is obtained by subjecting a porous film original sheet 23 to predetermined processes.

However, use of the winding process carried out by the winding device 180 in accordance with Embodiment 3 is not limited to a case where the heat-resistant separator 12a is wound but can be applied to production of a roll by winding a porous film original sheet 23 prior to production of the heat-resistant separator 12a.

More specifically, for example, the above winding process can be used in the step of winding a film 22C which has been obtained by rolling polyolefin and subjected to cleaning with hydrochloric acid.

Further, the above winding process can also be used, for example, in the step of winding a film 22D which has been wound off and stretched.

### Embodiment 5

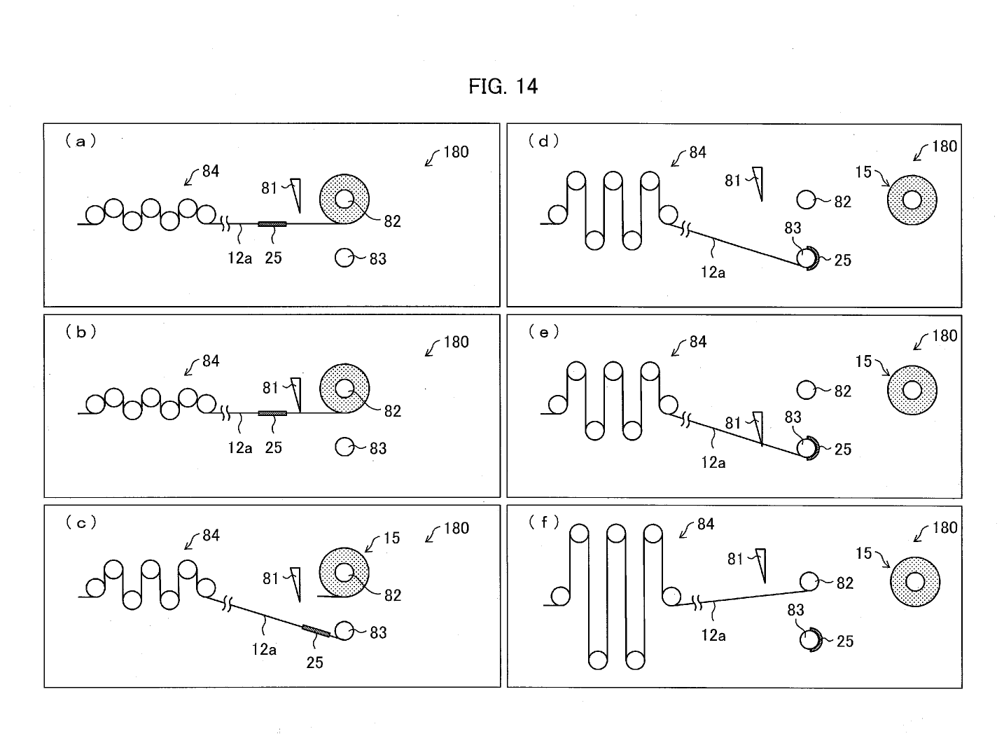

The following description discusses anther embodiment of the present invention, with reference to FIG. 14. Note that for convenience of description, each member identical to that described in any of the above Embodiments 1 to 4 is given an identical reference sign and a detailed description thereof will be omitted.

FIG. 14 illustrates a winding process which is carried out by a heat-resistant separator roll production apparatus in accordance with Embodiment 5. (a) of FIG. 14 illustrates a state in which a heat-resistant separator is being wound on a first roller, (b) of FIG. 14 illustrates a state in which the heat-resistant separator is being cut, (c) of FIG. 14 illustrates a state in which the heat-resistant separator is being wound on a second roller, (d) of FIG. 14 illustrates a state in which the heat-resistant separator having been wound is detached, (e) of FIG. 14 illustrates a state in which the heat-resistant separator is being cut again, and (f) of Fig. 14 illustrates a state in which the heat-resistant separator is being wound on the first roller again.

The heat-resistant separator roll production apparatus 301 (film roll production apparatus) is an apparatus for producing a heat-resistant separator roll 15 (film roll) that is obtained by winding a heat-resistant separator 12a in which a first heat-resistant separator (first film) and a second heat-resistant separator (second film) are joined to each other.

The heat-resistant separator roll production apparatus 301 includes a heat-resistant separator production apparatus 100 which is described in Embodiment 1 or 2, and a winding device 180 for carrying out a winding process of the heat-resistant separator 12a obtained in Embodiment 1 or 2.

As illustrated in (a) of FIG. 14, the winding device 180 includes a cutter 81, and a winding roller 82 (first roller) and a winding roller 83 (second roller). The winding roller 82 and the winding roller 83 each are a cylindrical member and rotate on an axis while receiving drive force that is provided by a revolving member (not illustrated), so that the winding rollers 82 and 83 each wind the heat-resistant separator 12a on an outer peripheral surface of the winding roller 82 or the winding roller 83. (a) of FIG. 14 illustrates a state in which the heat-resistant separator 12a is being wound on the winding roller 82.

As illustrated in (b) of FIG. 14, the cutter 81 cuts the heat-resistant separator 12a after completion of winding of the heat-resistant separator 12a on the winding roller 82. The cutter 81 here cuts the heat-resistant separator 12a on an upstream side of a joint portion 25. Note that the winding device 180 is notified, by a joint detecting device 30, of a time at which the joint portion 25 reaches the winding device 180.

As illustrated in (c) of FIG. 14, a roll production method (film roll production method) employing the winding device 180 in accordance with Embodiment 5 makes it possible to wind, on the winding roller 82, the heat-resistant separator 12a excluding the joint portion 25. Therefore, it is possible to produce a heat-resistant separator roll 15 which is obtained by winding only a necessary portion of the heat-resistant separator 12a and excludes the joint portion 25 unnecessary for the heat-resistant separator roll 15 as a product.

As illustrated in (c) of FIG. 14, after the heat-resistant separator 12a is cut, the winding device 180 switches from the winding roller 82 to the winding roller 83 on which the heat-resistant separator 12a is going to be wound, and winds, on the winding roller 83, the heat-resistant separator 12a on a downstream side of a cut position of the heat-resistant separator 12a.

As illustrated in (d) of FIG. 14, on the winding roller 83, the heat-resistant separator 12a including the joint portion 25 is wound. While the heat-resistant separator 12a is being wound on the winding roller 83, the heat-resistant separator roll 15 obtained by winding the heat-resistant separator 12a on the winding roller 82 is detached from the winding roller 82. Then, a winding core is attached to the winding roller 82 (not illustrated).

As illustrated in (e) of FIG. 14, the cutter 81 cuts the heat-resistant separator 12a after completion of winding of the joint portion 25 on the winding roller 83. The cutter 81 here cuts the heat-resistant separator 12a on a downstream side of the joint portion 25. Note that the winding device 180 is notified, by the joint detecting device 30, of a time at which the joint portion 25 reaches the winding device 180.

As illustrated in (f) of FIG. 14, after the heat-resistant separator 12a is cut, the winding device 180 switches from the winding roller 83 to the winding roller 82 on which the heat-resistant separator 12a is going to be wound, and winds, on the winding roller 82, the heat-resistant separator 12a on a downstream side of a cut position of the heat- resistant separator 12a.

The roll production method (film roll production method) employing the winding device 180 in accordance with Embodiment 5 makes it possible to wind, on the winding roller 83, the joint portion 25 unnecessary for a heat-resistant separator roll 15 as a product, and to produce the heat-resistant separator roll 15 which is obtained by winding only a necessary portion of the heat-resistant separator 12a.

Note that on the winding device 180 in accordance with Embodiment 5 is provided with an accumulator 84 on an upstream side of the winding device 180, the accumulate being provided for controlling transfer of the heat-resistant separator 12a. The accumulator 84 temporarily accumulates the heat-resistant separator 12a transferred thereto, and adjusts a length of the heat-resistant separator 12a to be supplied to the winding device 180 during a series of operation in the winding device 180.

[Main Points]

A film production apparatus in accordance with an embodiment of the present invention is a film production apparatus for producing a film by subjecting a film original sheet to predetermined processes, the film production apparatus including: a processing device for subjecting, to a process, the film original sheet in which a first film original sheet and a second film original sheet are joined to each other, the processing device carrying out the process in different manners, respectively, for a joint portion of the first film original sheet and the second film original sheet and for portions other than the joint portion.

In the above arrangement, when a film original sheet is processed, the joint portion and the portions other than the joint portion can be processed in different matters, respectively. This makes it possible to prevent a defect which may occur in a case where all portions of the film original sheet including the joint portion are uniformly processed.

The film production apparatus can be arranged to further include: a feeding device for joining the first film original sheet and the second film original sheet to each other and feeding the film original sheet; and a transfer device for transferring, at a predetermined transfer speed, the film original sheet thus fed, the processing device switching between the manners in which the process is carried out, in accordance with a time at which the joint portion reaches the processing device, the time being calculated on the basis of the predetermined transfer speed and a transfer distance from a current position of the joint portion to the processing device.

The above arrangement makes it possible to switch between the manner in which the joint portion is processed and the manner in which the portions other than the joint portion are processed, at an appropriate time on the basis of a transfer distance and a transfer speed.

The film production apparatus can be arranged such that: the processing device is a coating device for subjecting, to a coating process, the film original sheet being transferred; the coating device includes a coating section for applying a coating material to a surface of the film original sheet, the coating section coming in proximity to or in contact with the film original sheet so as to apply the coating material; and the coating device carries out the coating process such that a distance between the film original sheet and the coating section is larger in a case where the joint portion is coated than in a case where the portions other than the joint section are coated.

The above arrangement makes it possible to prevent, in the coating process, peeling of the first film original sheet or the second film original sheet in the joint portion from occurring due to application of stress onto the joint portion in a case where the coating section comes in proximity to or in contact with the joint portion.

The film production apparatus can be arranged to further include: a deposition device, as the processing device, for carrying out a deposition process after the coating process, the deposition device being arranged such that deposition capacity is higher in a case where the joint portion is subjected to the deposition process than in a case where the portions other than the joint portion are subjected to the deposition process.

In the coating process, in a case where the distance between the film original sheet and the coating section is larger in a case where the joint portion is coated, the joint portion is coated with a coating material thicker than the portions other than the joint portion.

In the above arrangement, the depositing capacity is higher in a case where the joint portion is subjected to the deposition process. This makes it possible to prevent a defect in a subsequent step from occurring due to insufficient deposition in the joint portion.

The film production apparatus can be arranged to further include: a drying device, as the processing device, for carrying out a drying process after the coating process, the drying device being arranged such that a drying capacity is higher in a case where the joint portion is subjected to the drying process than in a case where the portions other than the joint portion are subjected to the drying process.

In the coating process, in a case where the distance between the film original sheet and the coating section is larger in a case where the joint portion is coated, the joint portion is coated with a coating material thicker than the portions other than the joint portion.

In the above arrangement, the drying capacity is higher in a case where the joint portion is subjected to the drying process. This makes it possible to prevent a defect in a subsequent step from occurring due to insufficient drying in the joint portion.

The film production apparatus can be arranged such that: the processing device is a coating device for subjecting, to a coating process, the film original sheet being transferred; the coating device includes a coating section for applying a coating material to a surface of the film original sheet, the coating section coming in proximity to or in contact with the film original sheet so as to apply the coating material; and the coating device carries out the coating process such that: when the portions other than the joint portion are coated, the coating process is carried out all over the first film original sheet and the second film original sheet which follows the first film original sheet; and when the joint portion is coated, the coating process is carried out only on the first film original sheet that is provided closer to the coating section than the second film original sheet, but not on the second film original sheet that is provided farther from the coating section than the first film original sheet.

In the above arrangement, when the joint portion is subjected to the coating process, the coating process is carried out, in the joint portion, on the surface of the first film original sheet that is provided so as to be closer to the coating section than the second film original sheet which follows the first film original sheet. This makes it possible to avoid a situation in which the coating section comes in proximity to or in contact with the joint portion and applies, to the joint portion, stress in a direction in which the stress causes peeling of the first film original sheet or the second film original sheet in the joint portion. Accordingly, peeling of the first film original sheet or the second film original sheet in the joint portion can be prevented.

The film production apparatus can be arranged such that: the first film original sheet and the second film original sheet are joined in the joint portion to each other, via an adhesive which contains olefin; and the coating material contains a polar solvent as a solvent.

The above configuration makes it possible to join the first film original sheet and the second film original sheet to each other at a sufficient joint strength. Moreover, the coating process can be carried out with a sufficient coating property. Further, since olefin is resistant to a polar solvent such as NMP, peeling of the first film original sheet or the second film original sheet in the joint portion due to decrease in joint strength can be prevented even in a case where the coating material in the coating process penetrates the film and reaches the adhesive.

The film production apparatus can be arranged such that: the processing device is an inspection device for inspecting the film original sheet being transferred; and the inspection device carries out no inspection of the joint portion.

In the above arrangement, the joint portion is not inspected. However, in a case where the joint portion is not used in a product, no inspection of the joint portion is necessary. Therefore, in the above arrangement, an unnecessary inspection by the inspection device can be omitted. Further, in a case where the joint portion is inspected, a variation due to a joint may be detected as a defect. As a result, there is a risk that such a defect may be confused with a defect of a portion for use in a product, and taken as a defect of a product. Accordingly, such confusion can be prevented in a case where the joint portion is not inspected.

The film production apparatus can be arranged such that: the processing device is a winding device for subjecting the film original sheet to a winding process so as to form a roll of the film original sheet; and the winding device forms the roll of the film original sheet, by winding, on a winding roller, the film original sheet excluding the joint portion.

In a case where the joint portion is not used as a product, it is not necessary to wind the joint portion in the winding process. The above arrangement makes it possible to form a roll on which only a necessary portion of the film original sheet is wound.

The film production apparatus can be arranged such that: the winding device includes the winding roller as a first roller for winding the film original sheet, another winding roller as a second roller for winding the film original sheet, and a cutting section for cutting the film original sheet in a case where the winding roller for winding the film original sheet is to be switched to the another winding roller; and when the joint portion is wound on the first roller, the cutting section cuts the film original sheet on a downstream side of the joint portion and the film original sheet on a downstream side of a cut position is wound on the second roller, the cut position being a position where the film original sheet is cut.

In the above arrangement, when a portion of the film original sheet is wound on the first roller while another portion of the film original sheet is wound on the second roller, the film original sheet can be wound such that the joint portion is present on an outer periphery of the first roller. This makes it possible to easily cut the joint portion from the film original sheet thus wound.

Moreover, in order to solve the above problem, a film roll production apparatus in accordance with an embodiment of the present invention is a film roll production apparatus for producing a film roll by winding a film in which a first film and a second film are joined to each other, the film roll production apparatus including: a winding device for forming the film roll by winding, on a winding roller, the film excluding a joint portion of the first film and the second film.

In a case where the joint portion is not used in a product, it is not necessary to wind the joint portion in a winding process. The above arrangement makes it possible to form a film roll obtained by winding only a necessary portion of the film.

The film roll production apparatus can be arranged such that: the winding device includes the winding roller as a first roller for winding the film original sheet, and a cutting section for cutting the film in a case where the winding roller for winding the film is to be switched to another winding roller as a second roller for winding the film; and when the joint portion is wound on the first roller, the cutting section cuts the film on a downstream side of the joint portion and the film on a downstream side of a cut position is wound on the second roller, the cut position being a position where the film original sheet is cut.

In the above arrangement, when a portion of the film is wound on the first roller while another portion of the film is wound on the second roller, the film can be wound such that the joint portion is present on an outer periphery of the first roller. This makes it possible to easily cut the joint portion from the film thus wound on the first roller.

Further, in order to solve the above problem, a film production method in accordance with an embodiment of the present invention is a film production method for producing a film by subjecting a film original sheet to predetermined processes, the method including the step of: subjecting, to a process, the film original sheet in which a first film original sheet and a second film original sheet are joined to each other, the step carrying out the process in different manners, respectively, for a joint portion of the first film original sheet and the second film original sheet and for portions other than the joint portion.

Furthermore, in order to solve the above problem, a film roll production method in accordance with an embodiment of the present invention is a film roll production method for producing a film roll by winding a film in which a first film and a second film are joined to each other, the film roll production method comprising the step of: forming the film roll by winding, on a winding roller, the film excluding a joint portion of the first film and the second film.

[Additional Statement]

The present invention is not limited to the embodiments, but can be altered by a skilled person in the art within the scope of the claims. An embodiment derived from a proper combination of technical means each disclosed in a different embodiment is also encompassed in the technical scope of the present invention.

### REFERENCE SIGNS LIST

12 separator (film)
12a heat-resistant separator (film)
heat-resistant separator roll (film roll)
20 winding-off device
22A porous film (first film original sheet)
22B porous film (second film original sheet)
23 porous film original sheet (film original sheet)
25 joint portion
26 adhesive agent
30 joint portion detecting device
40, 140 coating device
42 coating material
43 coating bar (coating section)
50 deposition device
60 drying device
70 inspection device
80, 180 winding device
82 winding roller (first roller)
83 winding roller (second roller)
100 heat-resistant separator production apparatus (film production apparatus)
101, 201 heat-resistant separator roll production apparatus (film roll production apparatus)
R roller (transfer device)

1. A film production apparatus for producing a film by subjecting a film original sheet to predetermined processes, the film production apparatus comprising:
a processing device for subjecting, to a process, the film original sheet in which a first film original sheet and a second film original sheet are joined to each other,
the processing device carrying out the process in different manners, respectively, for a joint portion of the first film original sheet and the second film original sheet and for portions other than the joint portion.

2. The film production apparatus as set forth in claim 1, further comprising:
a feeding device for joining the first film original sheet and the second film original sheet to each other and feeding the film original sheet; and
a transfer device for transferring, at a predetermined transfer speed, the film original sheet thus fed,
the processing device switching between the manners in which the process is carried out, in accordance with a time at which the joint portion reaches the processing device, the time being calculated on the basis of the predetermined transfer speed and a transfer distance from a current position of the joint portion to the processing device.

3. The film production apparatus as set forth in claim 1, wherein:
the processing device is a coating device for subjecting, to a coating process, the film original sheet being transferred;
the coating device includes a coating section for applying a coating material to a surface of the film original sheet, the coating section coming in proximity to or in contact with the film original sheet so as to apply the coating material; and
the coating device carries out the coating process such that a distance between the film original sheet and the coating section is larger in a case where the joint portion is coated than in a case where the portions other than the joint section are coated.

4. The film production apparatus as set forth in claim 3, further comprising:
a deposition device, as the processing device, for carrying out a deposition process after the coating process,
the deposition device being arranged such that a deposition capacity is higher in a case where the joint portion is subjected to the deposition process than in a case where the portions other than the joint portion are subjected to the deposition process.

5. The film production apparatus as set forth in claim 3, further comprising:
a drying device, as the processing device, for carrying out a drying process after the coating process,
the drying device being arranged such that a drying capacity is higher in a case where the joint portion is subjected to the drying process than in a case where the portions other than the joint portion are subjected to the drying process.

6. The film production apparatus as set forth in claim 1, wherein:
the processing device is a coating device for subjecting, to a coating process, the film original sheet being transferred;
the coating device includes a coating section for applying a coating material to a surface of the film original sheet, the coating section coming in proximity to or in contact with the film original sheet so as to apply the coating material; and
the coating device carries out the coating process such that:
when the portions other than the joint portion are coated, the coating process is carried out all over the first film original sheet and the second film original sheet which follows the first film original sheet; and
when the joint portion is coated, the coating process is carried out only on the first film original sheet that is provided closer to the coating section than the second film original sheet, but not on the second film original sheet that is provided farther from the coating section than the first film original sheet.

7. The film production apparatus as set forth in claim 3, wherein:
the first film original sheet and the second film original sheet are joined in the joint portion to each other, via an adhesive which contains olefin; and
the coating material contains a polar solvent as a solvent.

8. The film production apparatus as set forth in claim 1, wherein:
the processing device is an inspection device for inspecting the film original sheet being transferred; and
the inspection device carries out no inspection of the joint portion.

9. The film production apparatus as set forth in claim 1, wherein:
the processing device is a winding device for subjecting the film original sheet to a winding process so as to form a roll of the film original sheet; and
the winding device forms the roll of the film original sheet, by winding, on a winding roller, the film original sheet excluding the joint portion.

10. The film production apparatus as set forth in claim 9, wherein:
the winding device includes the winding roller as a first roller for winding the film original sheet, another winding roller as a second roller for winding the film original sheet, and a cutting section for cutting the film original sheet in a case where the winding roller for winding the film original sheet is to be switched to the another winding roller; and
when the joint portion is wound on the first roller, the cutting section cuts the film original sheet on a downstream side of the joint portion and the film original sheet on a downstream side of a cut position cut is wound on the second roller, the cut position being a position where the film original sheet is cut.

11. A film roll production apparatus for producing a film roll by winding a film in which a first film and a second film are joined to each other, the film roll production apparatus comprising:
a winding device for forming the film roll by winding, on a winding roller, the film excluding a joint portion of the first film and the second film.

12. The film roll production apparatus as set forth in claim 11, wherein:
the winding device includes the winding roller as a first roller for winding the film original sheet, and a cutting section for cutting the film in a case where the winding roller for winding the film is to be switched to another winding roller as a second roller for winding the film; and
when the joint portion is wound on the first roller, the cutting section cuts the film on a downstream side of the joint portion and the film on a downstream side of a cut position is wound on the second roller, the cut position being a position where the film original sheet is cut.

13. A film production method for producing a film by subjecting a film original sheet to predetermined processes, the method comprising the step of:
subjecting, to a process, the film original sheet in which a first film original sheet and a second film original sheet are joined to each other,
the step carrying out the process in different manners, respectively, for a joint portion of the first film original sheet and the second film original sheet and for portions other than the joint portion.

14. A film roll production method for producing a film roll by winding a film in which a first film and a second film are joined to each other, the film roll production method comprising the step of:
forming the film roll by winding, on a winding roller, the film excluding a joint portion of the first film and the second film.
